(19) United States
(12) Patent Application Publication
(10) Pub. No.: US 2014/0313610 A1
(43) Pub. Date: Oct. 23, 2014

(54) Systems and Methods Selective Complexity Data Decoding

(71) Applicant: LSI CORPORATION, San Jose, CA (US)

(72) Inventors: Fan Zhang, Milpitas, CA (US); Shu Li, San Jose, CA (US); Jun Xiao, Fremont, CA (US)

(73) Assignee: LSI Corporation, San Jose, CA (US)

(21) Appl. No.: 13/868,779

(22) Filed: Apr. 23, 2013

Related U.S. Application Data
(60) Provisional application No. 61/814,594, filed on Apr. 22, 2013.

(51) Int. Cl. G11B 20/18

(52) U.S. Cl. CPC G11B 20/18
USPC 360/53

(57) ABSTRACT

The present inventions are related to systems and methods for data processing, and more particularly to systems and methods for performing data decoding including selective complexity data decoding.

### CROSS REFERENCE TO RELATED APPLICATION

The present application claims priority to U.S. Pat. App. No. 61/814,594 entitled “Systems and Methods Selective Complexity Data Decoding” and filed on Apr. 22, 2013 by Zhang et al. The entirety of each of the aforementioned reference is incorporated herein by reference for all purposes.

### FIELD OF THE INVENTION

The present inventions are related to systems and methods for data processing, and more particularly to systems and methods for performing data decoding.

### BACKGROUND

Various data processing systems have been developed including storage systems, cellular telephone systems, and radio transmission systems. In such systems data is transferred from a sender to a receiver via some medium. For example, in a storage system, data is sent from a sender (i.e., a write function) to a receiver (i.e., a read function) via a storage medium. As information is stored and transmitted in the form of digital data, errors are introduced that, if not corrected, can corrupt the data and render the information unusable. In some cases, the corruption cannot be corrected using standard processing.

Hence, for at least the aforementioned reasons, there exists a need in the art for advanced systems and methods for data decoding.

### BRIEF SUMMARY

The present inventions are related to systems and methods for data processing, and more particularly to systems and methods for performing data decoding.

Various embodiments of the present invention provides a data processing system includes a data decoder circuit that is operable to selectively apply either a low complexity data decoding algorithm to a decoder input or a high complexity data decoding algorithm to at least a portion of the decoder input depending upon a condition to yield a decoded output.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage system including a read channel circuit having selective complex decoding circuitry in accordance with various embodiments of the present invention;

FIG. 2 depicts a data transmission system including a receiver having selective complex decoding circuitry in accordance with one or more embodiments of the present invention;

FIG. 3a shows a data processing circuit including a data decoder circuit including selective complex decoding circuitry in accordance with some embodiments of the present invention;

FIG. 3b depicts an example implementation of a data decoder circuit including selective complex decoding circuitry in accordance with various embodiments of the present invention;

FIGS. 4a-4b are flow diagrams showing a method for performing data processing including selective complexity data decoding in accordance with some embodiments of the present invention;

FIG. 5a graphically depicts an example of a trapping set from which a constraint selection is made; and

FIG. 5b graphically depicts a constraint selection derived from the trapping set of FIG. 5a that may be used in relation to one or more embodiments of the present invention.

### DETAILED DESCRIPTION OF THE INVENTION

The present inventions are related to systems and methods for data processing, and more particularly to systems and methods for performing data decoding.

In some embodiments of the present invention a data processing system is disclosed that includes a data decoder circuit. The data decoder circuit is operable to selectively apply a low complexity data decoding algorithm or a higher complexity data decoding algorithm. In some cases, the low complexity data decoding algorithm is a min sum data decoding algorithm, and the high complexity data decoding algorithm is a selective integer programming data decoding algorithm or a selective linear data decoding programming algorithm. In some cases, the high complexity data decoding is applied to only a subset of data to which the low complexity data decoding algorithm is applied.

In various cases, the aforementioned data processing system includes a data detector circuit and a data decoder circuit. The data detector circuit is operable to apply a data detection algorithm to a codeword to yield a detected output, and the data decoder circuit is operable to selectively apply a data decode algorithm to a decoder input derived from the detected output to yield a decoded output. Processing a codeword through both the data detector circuit and the data decoder circuit is generally referred to as a “global iteration”. During a global iteration, the data decode algorithm may be repeated applied. Each application of the data decode algorithm during a given global iteration is referred to as a “local iteration”.

Various embodiments of the present invention provides a data processing system includes a data decoder circuit that is operable to selectively apply either a low complexity data decoding algorithm to a decoder input or a high complexity data decoding algorithm to at least a portion of the decoder input depending upon a condition to yield a decoded output. In some cases, the system is implemented as an integrated circuit. In one or more instances of the aforementioned embodiments, the high complexity data decoding algorithm may be, but is not limited to, an integer programming data decoding algorithm, or a linear data decoding programming algorithm. In some instances of the aforementioned embodiments, the low complexity data decoding algorithm may be, but is not limited to, a min sum data decoding algorithm, and a belief propagation data decoding algorithm.

In various instances of the aforementioned embodiments, the condition includes a number of unsatisfied checks in the decoded output. In some such instances, the low complexity data decoding algorithm is selected when either the high complexity data decoding algorithm was used during a preceding local iteration of the data decoder circuit or the number of unsatisfied checks is greater than a threshold value. The threshold value may be either programmable or fixed. In various cases, the high complexity data decoding algorithm is selected when the number of unsatisfied checks is less than a threshold value.

In various instances of the aforementioned embodiments, the portion of the decoder input is selected to include the unsatisfied checks remaining in the decoded output, and less than all of the decoder input. In some instances of the aforementioned embodiments, the portion of the decoder input is selected to include the unsatisfied checks remaining in the decoded output, and less than all of the decoder input. Yet other instances of the aforementioned embodiments, the portion of the decoder input is selected to include at least one of the unsatisfied checks remaining in the decoded output and at least one other satisfied check, and less than all of the decoder input. In yet other instances of the aforementioned embodiments, the portion of the decoder input is selected to include the most unreliable unsatisfied check of the unsatisfied checks remaining in the decoded output, and less than all of the decoder input.

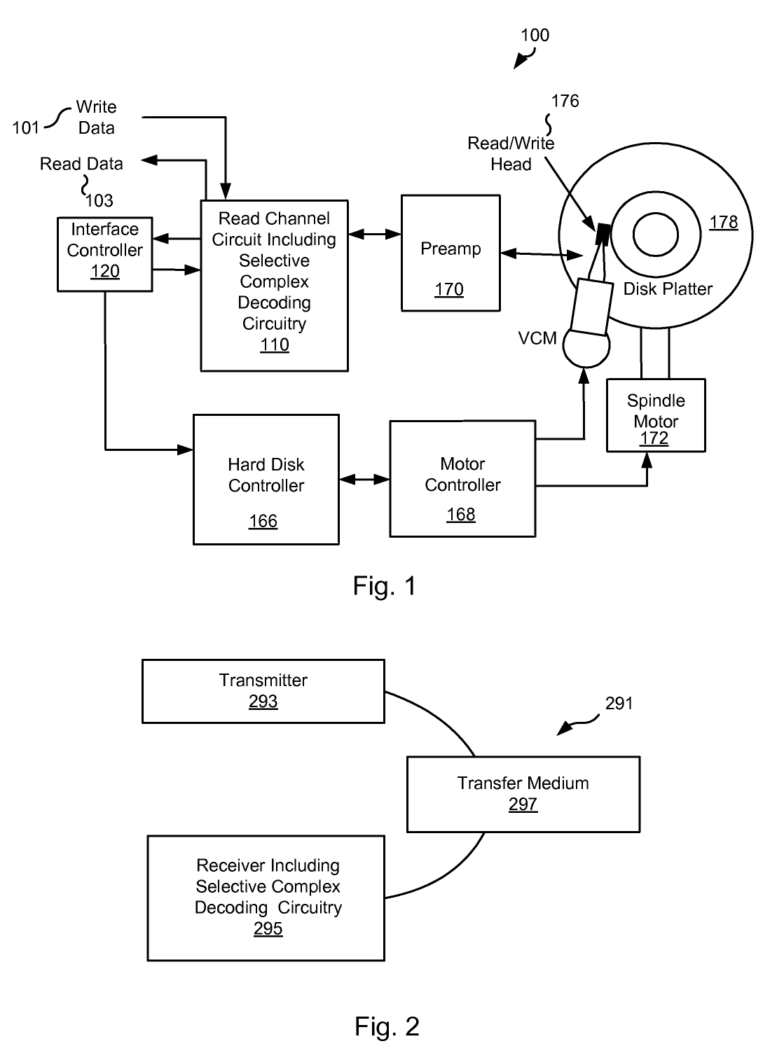

Turning to FIG. 1, a storage system 100 including a read channel circuit 110 having multi-scaling value data decoder circuitry in accordance with various embodiments of the present invention. Storage system 100 may be, for example, a hard disk drive. Storage system 100 also includes a preamplifier 170, an interface controller 120, a hard disk controller 166, a motor controller 168, a spindle motor 172, a disk platter 178, and a read/write head 176. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

In a typical read operation, read/write head assembly 176 is accurately positioned by motor controller 168 over a desired data track on disk platter 178. Motor controller 168 both positions read/write head assembly 176 in relation to disk platter 178 and drives spindle motor 172 by moving read/write head assembly to the proper data track on disk platter 178 under the direction of hard disk controller 166. Spindle motor 172 spins disk platter 178 at a determined spin rate (RPMs). Once read/write head assembly 176 is positioned adjacent the proper data track, magnetic signals representing data on disk platter 178 are sensed by read/write head assembly 176 as disk platter 178 is rotated by spindle motor 172. The sensed magnetic signals are provided as a continuous, minute analog signal representative of the magnetic data on disk platter 178. This minute analog signal is transferred from read/write head assembly 176 to read channel circuit 110 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to a receiving circuit. A write operation is substantially the opposite of the preceding read operation with write data 101 being provided to read channel circuit 110. This data is then encoded and written to disk platter 178.

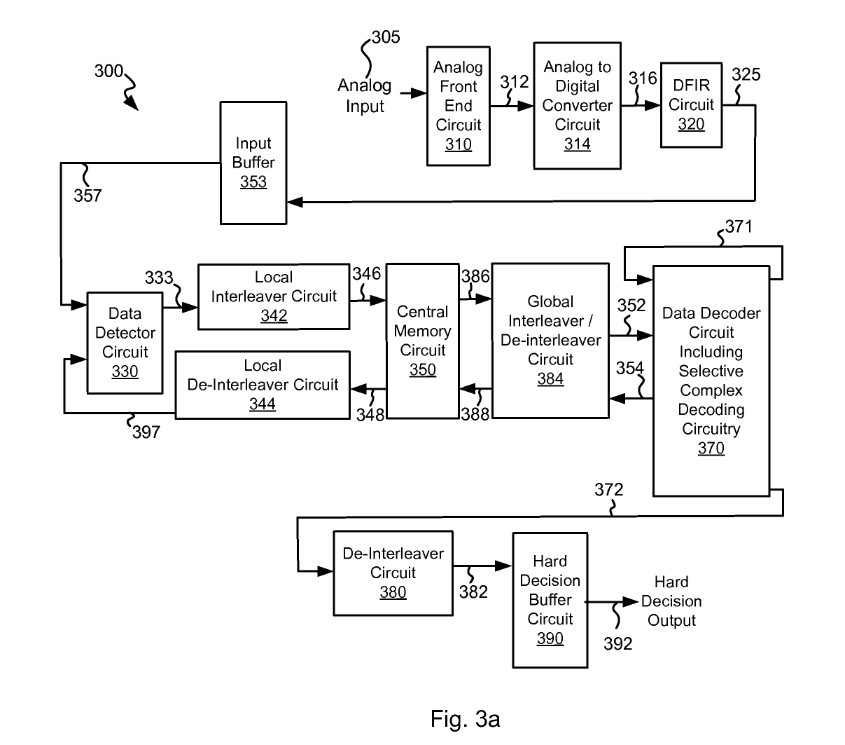

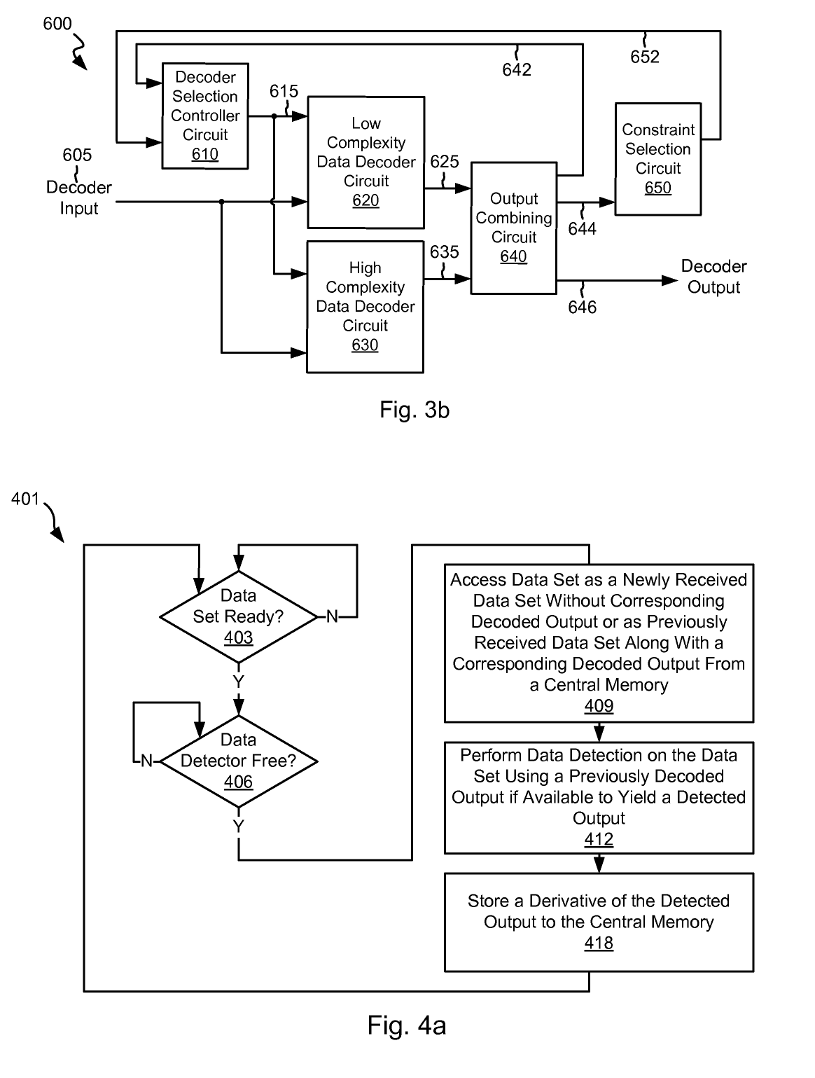

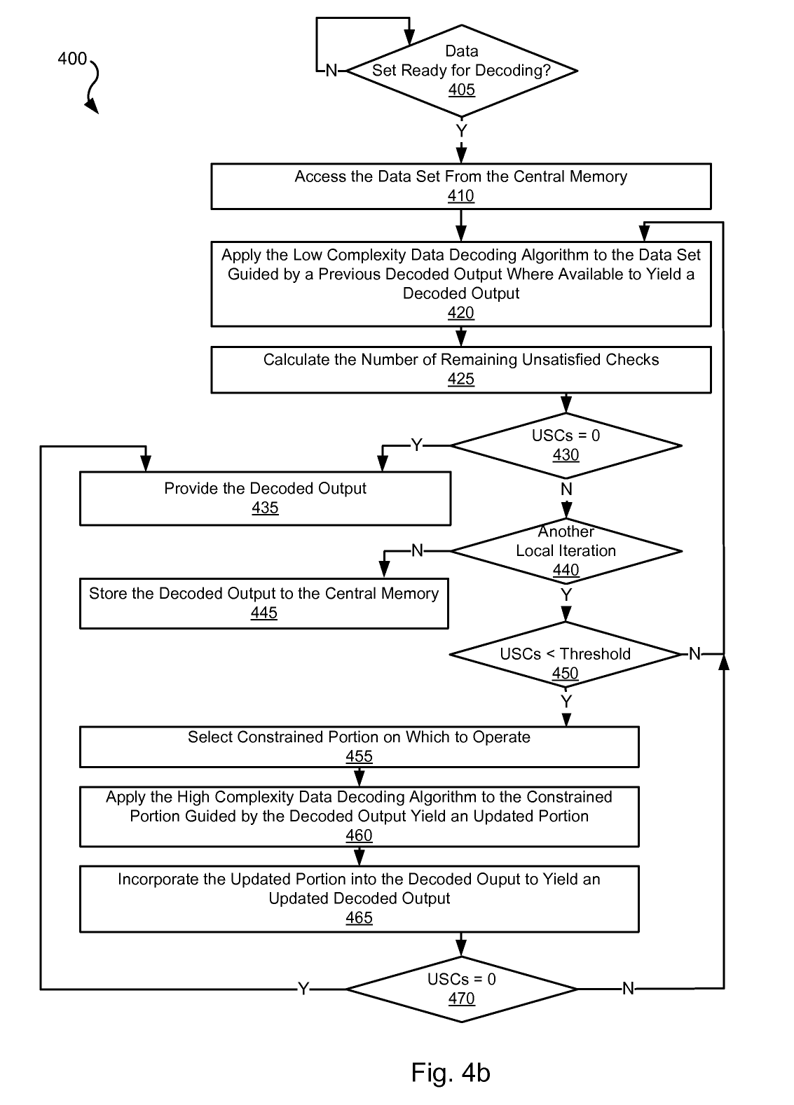

As part of processing the received information, read channel circuit 110 utilizes data decoding circuitry that includes a data decoder circuit with an ability to selectively apply different data decoding algorithms depending upon one or more conditions evident after each local iteration through the data decoder circuit. In some cases, the condition includes a number of unsatisfied checks remaining at the end of a local iteration through the data decoder circuit. In some cases, read channel circuit 110 may be implemented to include a data processing circuit similar to that discussed below in relation to FIG. 3a and/r FIG. 3b. In one or more embodiments of the present invention, the data processing may be performed similar to that discussed below in relation to FIGS. 4a-4b.

It should be noted that storage system 100 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 100, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 110 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In addition, it should be noted that storage system 100 may be modified to include solid state memory that is used to store data in addition to the storage offered by disk platter 178. This solid state memory may be used in parallel to disk platter 178 to provide additional storage. In such a case, the solid state memory receives and provides information directly to read channel circuit 110. Alternatively, the solid state memory may be used as a cache where it offers faster access time than that offered by disk platted 178. In such a case, the solid state memory may be disposed between interface controller 120 and read channel circuit 110 where it operates as a pass through to disk platter 178 when requested data is not available in the solid state memory or when the solid state memory does not have sufficient storage to hold a newly written data set. Based upon the disclosure provided herein, one of ordinary skill in the art will recognize a variety of storage systems including both disk platter 178 and a solid state memory.

Turning to FIG. 2, a data transmission system 291 including a receiver 295 having skip layer enabled data decoder circuitry in accordance with various embodiments of the present invention. Data transmission system 291 includes a transmitter 293 that is operable to transmit encoded information via a transfer medium 297 as is known in the art. The encoded data is received from transfer medium 297 by a receiver 295. Receiver 295 processes the received input to yield the originally transmitted data.

As part of processing the received information, receiver 295 utilizes data decoding circuitry that includes a data decoder circuit with an ability to selectively apply different data decoding algorithms depending upon one or more conditions evident after each local iteration through the data decoder circuit. In some cases, the condition includes a number of unsatisfied checks remaining at the end of a local iteration through the data decoder circuit. In some cases, receiver 295 may be implemented to include a data processing circuit similar to that discussed below in relation to FIG. 3a and/r FIG. 3b. In one or more embodiments of the present invention, the data processing may be performed similar to that discussed below in relation to FIGS. 4a-4b.

Turning to FIG. 3a, a data processing circuit 300 including a data decoder circuit 370 including selective complex decoding circuitry is shown in accordance with some embodiments of the present invention. Data processing circuit 300 includes an analog front end circuit 310 that receives an analog signal 305. Analog front end circuit 310 processes analog signal 305 and provides a processed analog signal 312 to an analog to digital converter circuit 314. Analog front end circuit 310 may include, but is not limited to, an analog filter and an amplifier circuit as are known in the art. Based upon the disclosure provided herein, one of ordinary skill in the art will recognize a variety of circuitry that may be included as part of analog front end circuit 310. In some cases, analog signal 305 is derived from a read/write head assembly (not shown) that is disposed in relation to a storage medium (not shown). In other cases, analog signal 305 is derived from a receiver circuit (not shown) that is operable to receive a signal from a transmission medium (not shown). The transmission medium may be wired or wireless. Based upon the disclosure provided herein, one of ordinary skill in the art will recognize a variety of source from which analog input 305 may be derived.

Analog to digital converter circuit 314 converts processed analog signal 312 into a corresponding series of digital samples 316. Analog to digital converter circuit 314 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 316 are provided to an equalizer circuit 320. Equalizer circuit 320 applies an equalization algorithm to digital samples 316 to yield an equalized output 325. In some embodiments of the present invention, equalizer circuit 320 is a digital finite impulse response filter circuit as are known in the art. It may be possible that equalized output 325 may be received directly from a storage device in, for example, a solid state storage system. In such cases, analog front end circuit 310, analog to digital converter circuit 314 and equalizer circuit 320 may be eliminated where the data is received as a digital data input. Equalized output 325 is stored to an input buffer 353 that includes sufficient memory to maintain a number of codewords until processing of that codeword is completed through a data detector circuit 330 and data decoder circuit 370 including, where warranted, multiple global iterations (passes through both data detector circuit 330 and data decoder circuit 370) and/or local iterations (passes through data decoder circuit 370 during a given global iteration). An output 357 is provided to data detector circuit 330.

Data detector circuit 330 may be a single data detector circuit or may be two or more data detector circuits operating in parallel on different codewords. Whether it is a single data detector circuit or a number of data detector circuits operating in parallel, data detector circuit 330 is operable to apply a data detection algorithm to a received codeword or data set. In some embodiments of the present invention, data detector circuit 330 is a Viterbi algorithm data detector circuit as are known in the art. In other embodiments of the present invention, data detector circuit 330 is a maximum a posteriori data detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention. In some cases, one data detector circuit included in data detector circuit 330 is used to apply the data detection algorithm to the received codeword for a first global iteration applied to the received codeword, and another data detector circuit included in data detector circuit 330 is operable apply the data detection algorithm to the received codeword guided by a decoded output accessed from a central memory circuit 350 on subsequent global iterations.

Upon completion of application of the data detection algorithm to the received codeword on the first global iteration, data detector circuit 330 provides a detector output 333. Detector output 333 includes soft data. As used herein, the phrase “soft data” is used in its broadest sense to mean reliability data with each instance of the reliability data indicating a likelihood that a corresponding bit position or group of bit positions has been correctly detected. In some embodiments of the present invention, the soft data or reliability data is log likelihood ratio data as is known in the art. Detector output 333 is provided to a local interleaver circuit 342. Local interleaver circuit 342 is operable to shuffle sub-portions (i.e., local chunks) of the data set included as detected output and provides an interleaved codeword 346 that is stored to central memory circuit 350. Interleaver circuit 342 may be any circuit known in the art that is capable of shuffling data sets to yield a re-arranged data set. Interleaved codeword 346 is stored to central memory circuit 350.

Once data decoder circuit 370 is available, a previously stored interleaved codeword 346 is accessed from central memory circuit 350 as a stored codeword 386 and globally interleaved by a global interleaver/de-interleaver circuit 384. Global interleaver/de-interleaver circuit 384 may be any circuit known in the art that is capable of globally rearranging codewords. Global interleaver/De-interleaver circuit 384 provides a decoder input 352 into data decoder circuit 370. On a first local iteration, data decoder circuit 370 applies a low complexity data decoding algorithm to decoder input 352 to yield a decoded output 371. In various embodiments of the present invention, the low complexity data decoding algorithm.

Where application of the low complexity data decoding algorithm results in no remaining unsatisfied checks (i.e., failed parity equations), the original data is recovered. In such a case, decoded output 371 is said to have converged and decoded output 371 is provided as an output codeword 372 to a de-interleaver circuit 380 that rearranges the data to reverse both the global and local interleaving applied to the data to yield a de-interleaved output 382. De-interleaved output 382 is provided to a hard decision buffer circuit 390 that arranges the received codeword along with other previously received codewords in an order expected by a requesting host processor. The resulting output is provided as a hard decision output 392.

Alternatively, where decoded output 371 fails to converge (i.e., includes remaining unsatisfied checks) to the originally written data set, it is determined whether another local iteration through data decoder circuit 370 is desired or allowed. As an example, in some embodiments of the present invention, ten (10) local iterations are allowed for each global iteration. Based upon the disclosure provided herein, one of ordinary skill in the art will recognize other numbers of local iterations that may be allowed in relation to the various embodiments of the present invention.

In cases where another local iteration (i.e., another pass trough data decoder circuit 370) is desired or allowed, data decoder circuit 370 determines whether the next local iteration will utilize the same low complexity data decoding algorithm or will utilize a higher complexity data decoding algorithm. In some embodiments of the present invention, the low complexity data decoding algorithm is a min sum data decoding algorithm. In other embodiments of the present invention, the low complexity data decoding algorithm may be, but is not limited to, a belief propagation data decoding algorithm. In some embodiments of the present invention, the high complexity data decoding algorithm is an integer programming data decoding algorithm. In other embodiments of the present invention, the high complexity data decoding algorithm may be, but is not limited to, a linear programming data decoding algorithm. The determination of whether the low complexity data decoding algorithm or the high complexity data decoding algorithm is to be applied is made based upon the number of unsatisfied checks remaining in decoded output 371. In one particular case, where the number of remaining unsatisfied checks is less than a threshold value, the higher complexity data decoding algorithm is applied. Whereas, when the number of remaining unsatisfied checks is greater than or equal to the threshold value, the low complexity data decoding algorithm is applied.

All of the min sum data decoding algorithm, belief propagation data decoding algorithm, linear programming data decoding algorithm, and integer programming data decoding algorithm used alone are known in the art. Min sum decoding is an approximation of belief propagation data decoding that offers reduced complexity compared with belief propagation decoding by eliminating the convolution on the incoming message, and rather just takes a minimum. Such a reduction in complexity comes at the price of a reduction in performance. The belief propagation decoding is a less complex alternative to maximum likelihood decoding. Maximum likelihood propagation decoding operates to enumerate all possible solutions, and to select the best possible solution. As an example, where a N-bit codeword is being decoded, the complexity is 2^{N} possibilities. The belief propagation decoding limits the number of possibilities, and therefore reduces complexity, but results in the possibility that the correct solution will not be investigated. The integer programming data decoding algorithm exhibits the same 2^{N} complexity of the maximum likelihood decoding. The linear programming data decoding algorithm exhibits lower complexity than the related integer programming data decoding algorithm as it only allows possible solutions along a defined polynomial.

In some embodiments of the present invention, where data decoder circuit 370 determines that the next local iteration will utilize the higher complexity data decoding algorithm, application of the higher complexity data decoding algorithm is limited to only a subset of data to which the low complexity data decoding algorithm was previously applied. By operating on only a subset of the data, the resources required to implement the higher complexity data decoding algorithm is rendered manageable.

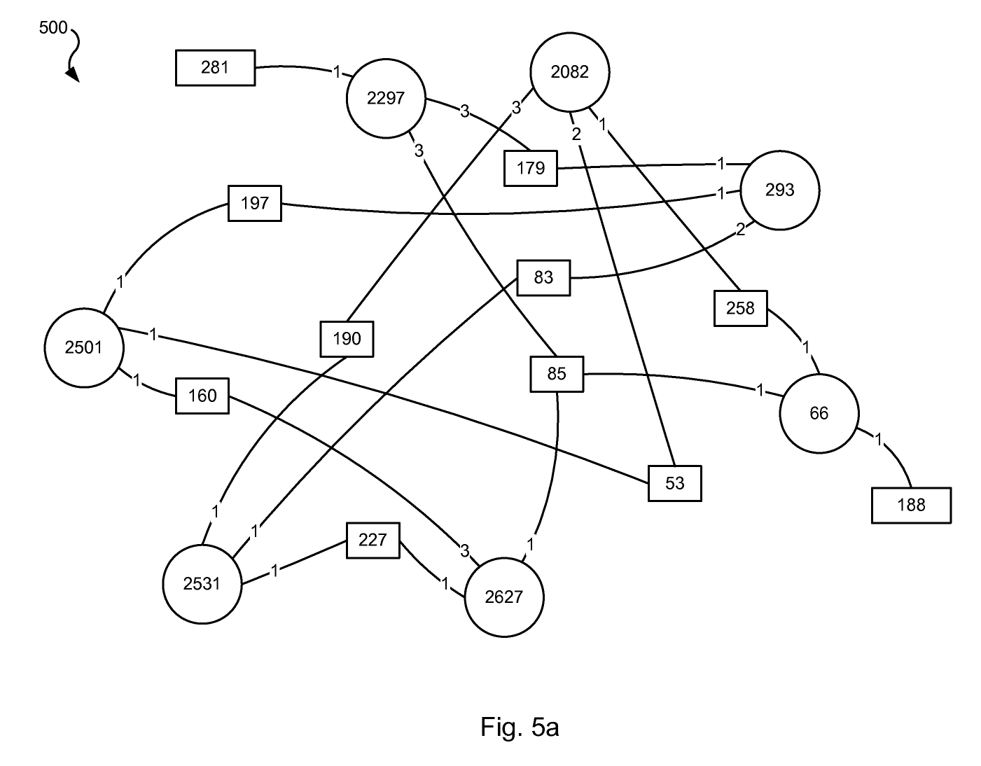

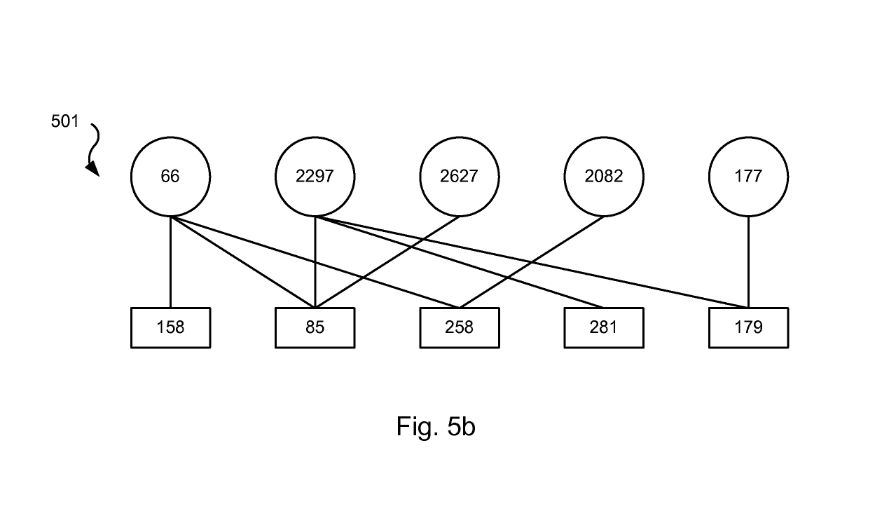

The subset of data to which the higher complexity data decoding algorithm is applied is selected based upon where the most likely errors remain. Different embodiments of the present invention select the subset of data based upon different criteria. In one particular embodiment, the subset of data is chosen as the unsatisfied checks, and a defined number of variable nodes corresponding to the unsatisfied checks. In another particular embodiment of the present invention, the subset of data is chosen as the unsatisfied checks, and a varying number of variable nodes corresponding to the unsatisfied checks. In such a case, the varying number varies depending upon the total number of unsatisfied checks. Where a higher number of unsatisfied checks remain, a lower number of variable nodes per unsatisfied checks is used; and where a lower number of unsatisfied checks remain, a higher number of variable nodes per unsatisfied checks is used. In yet another particular embodiment of the present invention, the subset of data is chosen as the unsatisfied checks and one or more neighboring checks, and a defined number of variable nodes corresponding to the unsatisfied checks. In yet a further particular embodiment of the present invention, the subset of data is chosen as the unsatisfied checks and one or more neighboring checks, and a varying number of variable nodes corresponding to the unsatisfied checks. Again, in such a case, the varying number varies depending upon the total number of unsatisfied checks. In yet another particular embodiment of the present invention, the subset of data is chosen as the most unreliable unsatisfied checks, and a defined number of variable nodes corresponding to the selected unsatisfied checks. In yet a further particular embodiment of the present invention, the subset of data is chosen as the most unreliable unsatisfied checks, and a varying number of variable nodes corresponding to the selected unsatisfied checks. Again, in such a case, the varying number varies depending upon the total number of selected unsatisfied checks. An example of selecting unsatisfied checks and related nodes is discussed below in relation to FIGS. 5a-5b.

Upon completion of the next local iteration, it is determined whether any unsatisfied checks remain. Where no unsatisfied checks remain, the decoding process of data decoder circuit 370 ends and decoded output 371 is provided as output codeword 372. Alternatively, where unsatisfied checks remain and the current local iteration applied the low complexity data decoding algorithm, then the aforementioned process of determining whether the next local iteration will be done using the low complexity data decoding algorithm or the higher complexity data decoding algorithm is performed followed by application of the selected data decoding algorithm during the next local iteration. As another alternative, where unsatisfied checks remain and the current local iteration applied the higher complexity data decoding algorithm, then the low complexity data decoding algorithm is applied during the next local iteration.

Where decoded output 371 fails to converge (i.e., fails to yield the originally written data set) and a number of local iterations through data decoder circuit 370 exceeds a threshold, the resulting decoded output is provided as a decoded output 354 back to central memory circuit 350 where it is stored awaiting another global iteration through a data detector circuit included in data detector circuit 330. Prior to storage of decoded output 354 to central memory circuit 350, decoded output 354 is globally de-interleaved to yield a globally de-interleaved output 388 that is stored to central memory circuit 350. The global de-interleaving reverses the global interleaving earlier applied to stored codeword 386 to yield decoder input 352. When a data detector circuit included in data detector circuit 330 becomes available, a previously stored de-interleaved output 388 is accessed from central memory circuit 350 and locally de-interleaved by a de-interleaver circuit 344. De-interleaver circuit 344 re-arranges decoder output 348 to reverse the shuffling originally performed by interleaver circuit 342. A resulting de-interleaved output 397 is provided to data detector circuit 330 where it is used to guide subsequent detection of a corresponding data set previously received as equalized output 325.

Turning to FIG. 3b, an example implementation of a data decoder circuit 600 including selective complex decoding circuitry is shown in accordance with various embodiments of the present invention. Data decoder circuit 600 may be used in place of data decoder circuit 370 described above in relation to FIG. 3a. Where such is the case, a decoder input 605 is connected to decoder input 352, and a decoder output 664 is connected to each of decoded output 354 and codeword output 372 depending upon whether more local iterations are allowed and/or convergence of decoder output 646. A decoder output 642 corresponds to decoded output 371.

Data decoder circuit 600 includes a low complexity data decoder circuit 620 and a high complexity data decoder circuit 630. Low complexity data decoder circuit 620 may be, but is not limited to, a min sum data decoder circuit or a belief propagation data decoder circuit. High complexity data decoder circuit 630 may be, but is not limited to, an integer programming data decoder circuit or a linear programming data decoder circuit. In addition, data decoder circuit 600 includes a decoder selection control circuit 610 that selects which of low complexity data decoder circuit 620 or high complexity data decoder circuit 630 operates on decoder input 605. A decoded output 625 from low complexity data decoder circuit 620 and a decoded output from high complexity data decoder circuit 630 are provided to an output combining circuit 640 that either overwrites previous decoding results with decoded output 625 when low complexity decoding is applied to decoder input 605, or overwrites portions of the previous decoding results with corresponding portions provided as decoded output 635 when high complexity decoding is applied to decoder input 605. Output combining circuit 640 provides the combined output as decoder output 646. In addition, output combining circuit 640 provides the combined output as decoder output 644 to a constraint selection circuit 650, and as decoder output 642 to decoder selection control circuit 610. Constraint selection circuit 650 is operable to identify which check nodes and variable nodes would be subject to processing by high complexity data decoder circuit 630 if high complexity decoding is desired.

In operation, decoder selection controller circuit 610 selects low complexity data decoder circuit 620 to decode decoder input 605 for a first local iteration through data decoder circuit 600 by asserting a control output 615 to indicate low complexity data decoder circuit 620. For the first local iteration, decoder output 642 is not valid and is not used to guide application of the low complexity data decoding algorithm. Low complexity data decoder circuit 620 applies the low complexity data decode algorithm to the entirety of decoder input 605 to yield decoded output 625 that is stored to output combining circuit 640 as a combined output. Output combining circuit 640 determines whether any unsatisfied checks remain in the combined output. Where no unsatisfied checks remain, decoder output 646 is provided as an output codeword. Alternatively, where unsatisfied checks remain, decoder selection controller circuit 610 determines whether the next local iteration will utilize the same low complexity data decoding algorithm applied by low complexity data decoder circuit 620, or will utilize a higher complexity data decoding algorithm applied by high complexity data decoder circuit 630. The determination of whether the low complexity data decoding algorithm or the high complexity data decoding algorithm is to be applied is made based upon the number of unsatisfied checks remaining in decoder output 642. In one particular case, where the number of remaining unsatisfied checks is less than a threshold value, the higher complexity data decoding algorithm is applied by high complexity data decoder circuit 630. Whereas, when the number of remaining unsatisfied checks in decoder output 642 is greater than or equal to the threshold value, the low complexity data decoding algorithm is applied by low complexity data decoder circuit 620. In some embodiments of the present invention, the threshold value is programmable. In other embodiments of the present invention, the threshold value is a fixed value. In one particular embodiment of the present invention, the threshold value is fixed at five (5). Based upon the disclosure provided herein, one of ordinary skill in the art will recognize other numbers that may be used for the threshold value.

In some embodiments of the present invention, where decoder selection controller circuit 610 determines that the next local iteration will utilize the higher complexity data decoding algorithm applied by high complexity data decoder circuit 630, application of the higher complexity data decoding algorithm is limited to only a subset of data to which the low complexity data decoding algorithm was previously applied. The subset of data is selected by constraint selection circuit 650 and indicated by a subset output 652 provided to decoder selection controller circuit 610. In such a case where high complexity data decoder circuit 630 is selected, control output 615 will indicate both high complexity data decoder circuit 630 and a subset of decoder input 605 corresponding to subset output 652. By operating on only a subset of decoder input 605, the resources required to implement the higher complexity data decoding algorithm by high complexity data decoder circuit 630 is rendered manageable.

The subset of decoder input 605 to which the higher complexity data decoding algorithm is applied is selected based upon where the most likely errors remain as determined by constraint selection circuit 650. Different embodiments of the present invention select the subset of decoder input 605 based upon different criteria. In one particular embodiment, the subset of decoder input 605 is selected by constraint selection circuit 650 as the unsatisfied checks, and a defined number of variable nodes corresponding to the unsatisfied checks. In another particular embodiment of the present invention, the subset of decoder input 605 is selected by constraint selection circuit 650 as the unsatisfied checks, and a varying number of variable nodes corresponding to the unsatisfied checks. In such a case, the varying number varies depending upon the total number of unsatisfied checks. Where a higher number of unsatisfied checks remain, a lower number of variable nodes per unsatisfied checks is used; and where a lower number of unsatisfied checks remain, a higher number of variable nodes per unsatisfied checks is used. In yet another particular embodiment of the present invention, the subset of decoder input 605 is selected by constraint selection circuit 650 as the unsatisfied checks and one or more neighboring checks, and a defined number of variable nodes corresponding to the unsatisfied checks. In yet a further particular embodiment of the present invention, the subset of decoder input 605 is selected by constraint selection circuit 650 as the unsatisfied checks and one or more neighboring checks, and a varying number of variable nodes corresponding to the unsatisfied checks. Again, in such a case, the varying number varies depending upon the total number of unsatisfied checks. In yet another particular embodiment of the present invention, the subset of decoder input 605 is selected by constraint selection circuit 650 as the most unreliable unsatisfied checks, and a defined number of variable nodes corresponding to the selected unsatisfied checks. In yet a further particular embodiment of the present invention, the subset of decoder input 605 is selected by constraint selection circuit 650 as the most unreliable unsatisfied checks, and a varying number of variable nodes corresponding to the selected unsatisfied checks. Again, in such a case, the varying number varies depending upon the total number of selected unsatisfied checks. An example of selecting unsatisfied checks and related nodes is discussed below in relation to FIGS. 5a-5b.

With the selected one of low complexity data decoder circuit 620 or high complexity data decoder circuit 630 and, where applicable, the subset of decoder input 605 indicated by control output 615, the selected decoder algorithm is applied by the selected one of low complexity data decoder circuit 620 or high complexity data decoder circuit 630 to yield either decoded output 625 or decoded output 635 that are provided to output combining circuit 640. Where decoded output 625 is provided, it is written over the entirety of the combined output that was previously provided as decoder output 642 and decoder output 646. Alternatively, as decoded output 635 represents only a subset of a decoded output, it is written over only the corresponding portions of the combined output that was previously provided as decoder output 642 and decoder output 646. The combined output is then provided as decoder output 642, decoder output 646, and decoder output 644.

Upon completion of the current local iteration through data decoder circuit 600, it is again determined whether there are any unsatisfied checks remaining in decoder output 646. Where no unsatisfied checks remain, decoder output 646 is provided as an output codeword. Alternatively, where unsatisfied checks remain, decoder selection controller circuit 610 determines whether another local iteration is allowed or desired, and if allowed, whether the next local iteration will utilize the low complexity data decoding algorithm applied by low complexity data decoder circuit 620, or will utilize a higher complexity data decoding algorithm applied by high complexity data decoder circuit 630. Where unsatisfied checks remain, additional local iterations are allowed, and the data decoding algorithm applied during the previous local iteration was the low complexity data decoding algorithm, then the aforementioned process of determining whether the next local iteration will be done using the low complexity data decoding algorithm applied by low complexity data decoder circuit 620 or the higher complexity data decoding algorithm applied by high complexity data decoder circuit 630 is performed followed by application of the selected data decoding algorithm during the next local iteration. As another alternative, where unsatisfied checks remain, additional local iterations are allowed, and the current local iteration applied the higher complexity data decoding algorithm, then the low complexity data decoding algorithm is applied by low complexity data decoder circuit 620 during the next local iteration.

Turning to FIGS. 4a-4b, flow diagrams 400, 401 show a method for performing data processing including selective complexity data decoding in accordance with some embodiments of the present invention. Following flow diagram 401 of FIG. 4a, it is determined whether a data set or codeword is ready for application of a data detection algorithm (block 403). In some cases, a data set is ready when it is received from a data decoder circuit via a central memory circuit. In other cases, a data set is ready for processing when it is first made available from a front end processing circuit. Where a data set is ready (block 403), it is determined whether a data detector circuit is available to process the data set (block 406).

Where the data detector circuit is available for processing (block 406), the data set is accessed by the available data detector circuit (block 409). The data detector circuit may be, for example, a Viterbi algorithm data detector circuit or a maximum a posteriori data detector circuit. Where the data set is a newly received data set (i.e., a first global iteration), the newly received data set is accessed. In contrast, where the data set is a previously received data set (i.e., for the second or later global iterations), both the previously received data set and the corresponding decode data available from a preceding global iteration (available from a central memory) is accessed. The accessed data set is then processed by application of a data detection algorithm to the data set (block 412). Where the data set is a newly received data set (i.e., a first global iteration), it is processed without guidance from decode data available from a data decoder circuit. Alternatively, where the data set is a previously received data set (i.e., for the second or later global iterations), it is processed with guidance of corresponding decode data available from preceding global iterations. Application of the data detection algorithm yields a detected output. A derivative of the detected output is stored to the central memory (block 418). The derivative of the detected output may be, for example, an interleaved or shuffled version of the detected output.

Following flow diagram 400 of FIG. 4b, it is determined whether a data set or codeword is ready for processing by a data decoder circuit (block 405). Where a data set is ready for processing (block 405), the data set is accessed from the central memory (block 410). A low complexity data decoding algorithm is applied to the data set guided by a previous decoded output where available to yield a decoded output (block 420). In some embodiments of the present invention, the low complexity data decoding algorithm is a min sum data decoding algorithm. In other embodiments of the present invention, the low complexity data decoding algorithm may be, but is not limited to, a belief propagation data decoding algorithm.

The number of remaining unsatisfied checks in the decoded output is calculated or determined (block 425). This is done by determining which if any parity check equations in a processing data set remain unsatisfied after the decoding process. Where the number of remaining unsatisfied checks is zero (block 430), the data decoding process is considered to have completed and the decoded output is provided (block 435).

Otherwise, where any unsatisfied checks remain (block 435), processing continues by determining whether another local iteration is allowed (block 440). In some cases, seven (7) local iterations are allowed for each global iteration. Based upon the disclosure provided herein, one of ordinary skill in the art will recognize other numbers of allowable local iterations that may be used in relation to different embodiments of the present invention. Where no additional local iterations are allowed (block 440), the decoded output is stored back to the central memory to await the next global iteration (block 445).

Alternatively, where at least one more local iteration is allowed (block 440), it is determined whether the number of remaining unsatisfied checks is below a threshold value (block 450). In some embodiments of the present invention, the threshold value is programmable. In other embodiments of the present invention, the threshold value is a fixed value. In one particular embodiment of the present invention, the threshold value is fixed at five (5). Based upon the disclosure provided herein, one of ordinary skill in the art will recognize other numbers that may be used for the threshold value. Where the number remaining unsatisfied checks is not below the threshold value (block 450), another local iteration using the low complexity data decoding algorithm is applied (blocks 420-450).

Alternatively, where the number remaining unsatisfied checks is below the threshold value (block 450), a constrained portion of the data set is selected for reprocessing using a high complexity data decoding algorithm (block 455). The constrained portion of the data set to which the high complexity data decoding algorithm is applied is selected based upon where the most likely errors remain. Different embodiments of the present invention select the constrained portion of data based upon different criteria. In one particular embodiment, the constrained portion of data is chosen as the unsatisfied checks, and a defined number of variable nodes corresponding to the unsatisfied checks. In another particular embodiment of the present invention, the constrained portion of data is chosen as the unsatisfied checks, and a varying number of variable nodes corresponding to the unsatisfied checks. In such a case, the varying number varies depending upon the total number of unsatisfied checks. Where a higher number of unsatisfied checks remain, a lower number of variable nodes per unsatisfied checks is used; and where a lower number of unsatisfied checks remain, a higher number of variable nodes per unsatisfied checks is used. In yet another particular embodiment of the present invention, the constrained portion of data is chosen as the unsatisfied checks and one or more neighboring checks, and a defined number of variable nodes corresponding to the unsatisfied checks. In yet a further particular embodiment of the present invention, the constrained portion of data is chosen as the unsatisfied checks and one or more neighboring checks, and a varying number of variable nodes corresponding to the unsatisfied checks. Again, in such a case, the varying number varies depending upon the total number of unsatisfied checks. In yet another particular embodiment of the present invention, the constrained portion of data is chosen as the most unreliable unsatisfied checks, and a defined number of variable nodes corresponding to the selected unsatisfied checks. In yet a further particular embodiment of the present invention, the constrained portion of data is chosen as the most unreliable unsatisfied checks, and a varying number of variable nodes corresponding to the selected unsatisfied checks. Again, in such a case, the varying number varies depending upon the total number of selected unsatisfied checks.

The high complexity data decoding algorithm is the applied to the constrained portion of the data guided by the decoded output to yield an updated portion (block 460). In some embodiments of the present invention, the high complexity data decoding algorithm is an integer programming data decoding algorithm. In other embodiments of the present invention, the high complexity data decoding algorithm may be, but is not limited to, a linear programming data decoding algorithm. The updated portion is then incorporated into the decoded output to yield an updated decoded output (block 465). It is then determined whether there are any remaining unsatisfied checks in the updated decoded output (block 470). Where no unsatisfied checks remain (block 470), the data decoding process is considered to have completed and the decoded output is provided (block 435). Otherwise, the next local iteration is started by applying the low complexity data decoding algorithm (blocks 420-450).

FIG. 5a graphically depicts an example of a trapping set 500 from which a constraint selection is made. Trapping set 500 includes a number of variable nodes (i.e., circles 2297, 2082, 293, 66, 2627, 2531, 2501) and check nodes (i.e., rectangles 281, 197, 179, 258, 53, 227, 160, 190, 83, 85, 188) all associated with a trapping set. In this example, check nodes 188 and 281:2 are unsatisfied checks in a recent decoded output. Check node 188 is connected to the following variable nodes: 66, 186, 193, 302, 451, 511, 627, 715, 839, 906, 1043, 1147, 1206, 1251, 1354, 1479, 1614, 1668, 1756, 1833, 2001, 2080, 2134, 2210, 2356, 2405, 2529, 2655. The true hard decisions (THD), actual hard decisions (AHD), and variable node to check node messages (V2C) associated with the variable nodes included in the trapping set are shown in the following table:

| | VN | | | | | | |
|---|---|---|---|---|---|---|---|
| | 66 | 293 | 2082 | 2297 | 2501 | 2531 | 2627 |
| THD | 1 | 2 | 2 | 0 | 3 | 3 | 2 |
| AHD | 2 | 3 | 1 | 2 | 2 | 1 | 0 |
| QLLR | [−20, −2, 0, −20] | [−62, −60, −16, 0] | [−14, 0, −4, −14] | [0, −52, 0, −38] | [−46, −52, 0, −38] | [−34, 0, −28, −18] | [0, −32, −8, −46] |

Check node 188 is connected to the following variable nodes: 66, 186, 193, 302, 451, 511, 627, 715, 839, 906, 1043, 1147, 1206, 1251, 1354, 1479, 1614, 1668, 1756, 1833, 2001, 2080, 2134, 2210, 2356, 2405, 2529, 2655. The check node to variable node messages (C2V) associated with each of the preceding variable nodes is set forth in the following table:

| Variable Node | C2V |
|---|---|
| 66 | [−20, −2, 0, −20] |
| 186 | [−18, −34, 0, −28] |
| 193 | [−10, 0, −12, −38] |
| 302 | [−30, −34, −32, 0] |
| 451 | [−48, 0, −28, −42] |
| 511 | [0, −28, −22, −22] |
| 627 | [−30, −42, −50, 0] |
| 715 | [−44, −30, −52, 0] |
| 839 | [0, −34, −32, −40] |
| 906 | [0, −16, −32, −40] |
| 1043 | [−36, −30, −20, 0] |
| 1147 | [0, −38, −28, −34] |
| 1206 | [−34, −22, 0, −8] |
| 1251 | [0, −18, −40, −34] |
| 1354 | [−22, 0, −32, −18] |
| 1479 | [−44, −30, 0, −36] |
| 1614 | [−10, 0, −12, −44] |
| 1668 | [−28, −10, −20, 0] |
| 1756 | [0, −22, −60, −46] |
| 1833 | [−36, −26, −38, 0] |
| 2001 | [−32, −28, −32, 0] |
| 2080 | [−20, 0, −24, −22] |
| 2134 | [0, −38, −18, −36] |
| 2210 | [−36, −40, −34, 0] |
| 2356 | [−18, −20, −16, 0] |
| 2405 | [0, −46, −36, −58] |
| 2529 | [−42, 0, −44, −52] |
| 2655 | [−46, −36, 0, −46] |

The ‘0’ value in the C2V message indicates the selected hard decision (i.e., AHD). Thus, for example, in the message [0, −22, −60, −46] corresponding to variable node 1756, the hard decision is a ‘0’; in the message [−22, 0, −32, −18] corresponding to variable node 1354, the hard decision is a ‘1’; in the message [−20, −2, 0, −20] corresponding to variable node 66, the hard decision is a ‘2’; and in the message [−18, −20, −16, 0] corresponding to variable node 2356, the hard decision is a ‘3’. The second largest value in each message indicates the second most likely decision. In some embodiments of the present invention where the check node with the most unreliable unsatisfied check is selected for re-processing using the high complexity data decoding algorithm, variable node 66 is selected because the difference in the selected hard decision (AHD) and the next most likely hard decision is the smallest (i.e., 2) of all of the messages shown in the above mentioned table. Said another way, the most unreliable variable associated with the unsatisfied check of check node 188 is variable node 66.

Similarly, the most unreliable variable associated with the unsatisfied check of check node 281 is identified and selected. Check node 281 is connected to the following variable nodes: 89, 185, 281, 377, 473, 569, 665, 761, 857, 953, 1049, 1145, 1241, 1337, 1433, 1529, 1625, 1721, 1817, 1913, 2009, 2105, 2201, 2297, 2393, 2489, 2585, 2681. The check node to variable node messages (C2V) associated with each of the preceding variable nodes is set forth in the following table:

| Variable Node | C2V |
|---|---|
| 89 | [0, −46, −40, −54] |
| 185 | [−40, 0, −52, −46] |
| 281 | [−40, −18, −34, 0] |
| 377 | [−34, −28, −34, 0] |
| 473 | [0, −28, −22, −22] |
| 569 | [0, −26, −34, −40] |
| 665 | [−44, −30, −52, 0] |
| 761 | [0, −46, −32, −34] |
| 857 | [−60, −38, −38, 0] |
| 953 | [−40, −40, −34, 0] |
| 1049 | [−42, −40, −24, 0] |
| 1145 | [0, −36, −46, −56] |
| 1241 | [0, −28, −24, −32] |
| 1337 | [−22, −18, 0, −28] |
| 1433 | [−28, −42, 0, −40] |
| 1529 | [−42, −28, −40, 0] |
| 1625 | [−28, −10, −20, 0] |
| 1721 | [0, −20, −28, −32] |
| 1817 | [−50, −24, 0, −50] |
| 1913 | [−30, −42, 0, −24] |
| 2009 | [−56, −42, −60, 0] |
| 2105 | [−56, −46, −32, 0] |
| 2201 | [−46, −36, −8, 0] |
| 2297 | [0, −52, 0, −38] |
| 2393 | [−20, −18, −32, 0] |
| 2489 | [−20, −24, −36, 0] |
| 2585 | [−60, −54, −42, 0] |
| 2681 | [0, −44, −32, −36] |

Variable node 2297 is selected because the difference in the selected hard decision (AHD) and the next most likely hard decision is the smallest (i.e., 0) of all of the messages shown in the above mentioned table. Said another way, the most unreliable variable associated with the unsatisfied check of check node 281 is variable node 2297.

Next, the check nodes connected to the identified variable node 66 and variable node 2297 are identified. Variable node 66 is connected to check node 85 and check node 258, and variable node 2297 is connected to check node 85 and check node 179. Thus, the constraints are chosen as (i.e., constraints selected by constraint selection circuit 650 or block 455). Check node 188, check node 85, check node 258, check node 281, and check node 179. Next, the second most unreliable variables on the aforementioned constraints which are not unsatisfied checks. Thus, the second most unreliable variables on check node 85, check node 258, and check node 179 are determined. The second most unreliable variable on check node 85 is variable node 2627, the second most unreliable variable on check node 258 is variable node 2082, and the second most unreliable variable on check node 179 is variable node 177. Thus, the chosen variables are variable node 66, variable node 2297, variable node 2627, variable node 2082, and variable node 177.

Turning to FIG. 5b, a constraint selection 501 derived from the trapping set of FIG. 5a is graphically depicted that may be used in relation to one or more embodiments of the present invention. Constraint selection 501 includes only variable nodes 66, 2297, 2627, 2082, 177 and check nodes 158, 85, 258, 281, 179. When the high complexity data decoding algorithm is applied, it is applied only to the aforementioned constrained portion of the overall data set while maintaining all other variables as constants. The syndrome values are calculated only based on the selected constraints in the data decoding process.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system, the data processing system comprising:
a data decoder circuit operable to selectively apply either a low complexity data decoding algorithm to a decoder input or a high complexity data decoding algorithm to at least a portion of the decoder input depending upon a condition to yield a decoded output; and wherein the high complexity data decoding algorithm is selected from a group consisting of: an integer programming data decoding algorithm, and a linear data decoding programming algorithm.

2. The data processing system of claim 1, wherein the low complexity decoding algorithm is selected from a group consisting of: a min sum data decoding algorithm, and a belief propagation data decoding algorithm.

3. The data processing system of claim 1, wherein the condition includes a number of unsatisfied checks in the decoded output.

4. The data processing system of claim 1, wherein the low complexity data decoding algorithm is selected when either the high complexity data decoding algorithm was used during a preceding local iteration of the data decoder circuit or the number of unsatisfied checks is greater than a threshold value.

5. The data processing system of claim 4, wherein the threshold value is programmable.

6. The data processing system of claim 4, wherein the high complexity data decoding algorithm is selected when the number of unsatisfied checks is less than a threshold value.

7. The data processing system of claim 1, wherein the portion of the decoder input is selected to include the unsatisfied checks remaining in the decoded output, and less than all of the decoder input.

8. The data processing system of claim 1, wherein the portion of the decoder input is selected to include the unsatisfied checks remaining in the decoded output, and less than all of the decoder input.

9. The data processing system of claim 1, wherein the portion of the decoder input is selected to include at least one of the unsatisfied checks remaining in the decoded output and at least one other satisfied check, and less than all of the decoder input.

10. The data processing system of claim 8, wherein the portion of the decoder input is selected to include the most unreliable unsatisfied check of the unsatisfied checks remaining in the decoded output, and less than all of the decoder input.

11. The data processing system of claim 1, wherein the data processing system is implemented as an integrated circuit.

12. The data processing system of claim 1, wherein the data processing system is incorporated in a device selected from a group consisting of: a storage device, and a data transmission device.

13. The data processing system of claim 1, wherein the data processing system further comprises:
a data detector circuit operable to apply a data detection algorithm to a data input to yield a detected output, and wherein the decoder input is derived from the detected output.

14. A data processing method, the data processing method comprising:
receiving a decoder input;
applying a low density data decoding algorithm to the decoder input to yield a first decoded output;
selecting one of the low density data decoding algorithm or a high density data decoding algorithm as a selected decoding algorithm based at least in part on the first decoded output; wherein the high complexity data decoding algorithm is selected from a group consisting of: an integer programming data decoding algorithm, and a linear data decoding programming algorithm; and
applying the selected decoding algorithm to at least a portion of the decoder input to yield a second decoded output.

15. The method of claim 14, wherein the low complexity data decoding algorithm is selected from a group consisting of: a min sum data decoding algorithm, and a belief propagation data decoding algorithm.

16. The method of claim 14, wherein the selected decoding algorithm is the high complexity data decoding algorithm, and wherein the method further comprises:
selecting the portion of the decoder input based at least in part on the first decoded output.

17. The method of claim 16, wherein the portion of the decoder input is selected from a group consisting of:
at least the unsatisfied checks remaining in the decoded output, and less than all of the decoder input; at least one of the unsatisfied checks remaining in the decoded output and at least one other satisfied check, and less than all of the decoder input; and at least the most unreliable unsatisfied check of the unsatisfied checks remaining in the decoded output, and less than all of the decoder input.

18. The method of claim 14, wherein selecting one of the low density data decoding algorithm or the high density data decoding algorithm comprises:
selecting the low density data decoding algorithm when the number of unsatisfied checks is greater than a threshold value; and
selecting the high density data decoding algorithm when the number of unsatisfied checks is less than the threshold value.

19. A storage device, the storage device comprising:
a storage medium;
a head assembly disposed in relation to the storage medium and operable to provide a sensed signal corresponding to a data set on the storage;
a read channel circuit including:
an analog front end circuit operable to provide an analog signal corresponding to the sensed signal;
an analog to digital converter circuit operable to sample the analog signal to yield a series of digital samples;
an equalizer circuit operable to equalize the digital samples to yield a sample set;
a data decoder circuit operable to selectively apply either a low complexity data decoding algorithm to a decoder input derived from the sample set or a high complexity data decoding algorithm to at least a portion of the decoder input depending upon a condition to yield a decoded output; and wherein the high complexity data decoding algorithm is selected from a group consisting of: an integer programming data decoding algorithm, and a linear data decoding programming algorithm.

20. The storage device of claim 19, wherein the low complexity decoding algorithm is selected from a group consisting of: a min sum data decoding algorithm, and a belief propagation data decoding algorithm.
